(19) United States
(12) Patent Application Publication
(10) Pub. No.: US 2003/0209306 A1
(43) Pub. Date: Nov. 13, 2003

(54) Process for manufacturing flooring using recycled materials

(76) Inventors: Stuart A Jones, LaGrange, GA (US); James G Garrett, LaGrange, GA (US); Keith N Gray, Marietta, GA (US)

Correspondence Address: John S Pratt, Kilpatrick Stockton, Suite 2800, 1100 Peachtree Street, Atlanta, GA, 30309-4530, US

(21) Appl. No.: 10/312,413

(22) PCT Filed: Jun. 22, 2001
(86) PCT No.: PCT/US01/20073

(51) Int. Cl. B32B 5/00

(52) U.S. Cl. 156/72

(57) ABSTRACT

A continuous carpet (10) or other flooring manufacturing process that accommodates use of a variety of materials including recycled PVC from used carpet and carpet manufacturing waste. The continuous process forms backing (12) and is capable of feeding the backing into a lamination stage for bonding with the face cloth (14). By providing a continuous process whereby the backing layer, upon formation, can be immediately laminated to the face cloth, manufacturing time and associated cost are reduced. Moreover, formation of the backing layer as a process separate from the lamination thereby protecting the face cloth from unnecessary heat and pressure and enhancing the many types of material, including recycled and waste materials, especially used carpet and used carpet by products. Use of these cheaper materials reduces both the manufacturing cost by products. Use of these cheaper materials reduces both the manufacturing costs of the flooring and the amount of landfill waste and associated environmental concerns.

### FIELD OF THE INVENTION

This invention relates to the formation of flooring backing from materials recycled from carpet and carpet manufacturing waste and to commercial carpet, carpet tile and other flooring.

### BACKGROUND OF THE INVENTION

Commercial carpet, carpet tile and related textile fiber face flooring generally comprise a backing bonded to face cloth having a textile fiber upper wear surface. The face cloth may be yarn tufted into a tufting primary, yarn fusion bonded to a backing material, a woven or knitted fabric or a variety of other face layer structures. In some instances, the backing and the face cloth are formed independently and then laminated or bonded together to form the final flooring composite. In other instances one of the face cloth or backing is formed and the other of these components is then formed on the first. For instance, tufted face cloth may be formed by tufting yarn into a tufting primary, and then a backing may be formed on the underside of the face cloth while the face cloth is traversed through a production line up side down.

Historically, most carpet, carpet tile and related types of flooring have moved from use to landfills despite the great value of the materials from which the carpet is made. Some efforts at recycling carpet and flooring materials and components have been undertaken. For instance, used carpet and carpet manufacturing waste have been processed to separate face fiber from other components such as polyvinyl chloride (“PVC”) backing materials, which have been broken into material sometimes known as “PVC crumb.” Such PVC crumb has been formed by an extrusion process into carpet backing and then bonded to face cloth. There are limitations associated with such production of carpet or flooring backing. For instance, the crumb fed into the extruder generally needs to be of uniform shape and density. Moreover, the chemical composition of the feed materials must also be similar.

As an alternative to such production of backing by extrusion, and to reduce manufacturing time and costs, the backing might be formed and bonded to face cloth in a single step by positioning crumb and other backing components on the underside of inverted face cloth and then heating and pressing the resulting composite to bond all of the materials together. However, fusion of the backing layer components generally requires significant levels of heat and pressure. The face cloth may therefore be subjected to heat and pressure levels that crush the face cloth and otherwise compromise the appearance and integrity of the resulting flooring.

Thus, a need exists for an improved process of manufacturing flooring that reduces associated manufacturing time and costs by integrating the process and by expanding the types and physical attributes of the materials suitable for use in the process.

### SUMMARY OF THE INVENTION

This invention address many of the above-mentioned problems and others by providing a flooring manufacturing process that accommodates a variety of materials. The process provides for formation of backing and for bonding the backing to the face cloth in a continuous process. By providing a continuous process whereby the backing, upon formation, can be immediately laminated to the face cloth, manufacturing time and associated costs are reduced. However, backing also can be rolled and stored after production and then bonded to the face cloth at a later time.

Moreover, formation of the backing in a process separate from the lamination process allows separate control of the heat and pressure levels used in each of the backing formation and bonding processes, thereby protecting the face cloth against unnecessary heat and pressure and enhancing the appearance and integrity of the resulting flooring.

Additionally, the process of this invention is conducive to forming backing layer from almost any type of material, particularly including recycled and waste materials, especially used carpet and flooring and carpet and flooring manufacturing waste. Use of these cheaper materials reduces both the manufacturing costs of the flooring and the amount of landfill waste and associated environmental concerns.

### BRIEF DESCRIPTION OF THE DRAWINGS

FIG. 1 is a cross-sectional, schematic view of one embodiment of the flooring made according to the manufacturing process of this invention.

FIG. 2 is a cross-sectional, schematic view of an alternative embodiment of the flooring made according to the manufacturing process of this invention.

FIG. 3 is a side elevation view of one embodiment of the manufacturing process of this invention used to form a backing layer.

FIG. 4 is a side elevation view of the first dual scattering unit used in the manufacturing process of FIG. 3.

FIG. 5 is a side elevation view of the optional second dual scattering unit that can be used in the manufacturing process of FIG. 3.

FIG. 6 is a side elevation view of one embodiment of the manufacturing process of this invention used to laminate the face cloth to the backing layer formed from the manufacturing process shown in FIG. 3.

FIG. 7 is a side elevation view of an alternative embodiment of the manufacturing process of this invention used to laminate the face cloth to the backing layer formed from the manufacturing process shown in FIG. 3.

FIG. 8 is a side elevation view of yet another alternative embodiment of the manufacturing process of this invention used to laminate the face cloth to the backing layer formed from the manufacturing process shown in FIG. 3.

### DETAILED DESCRIPTIONS OF THE DRAWINGS

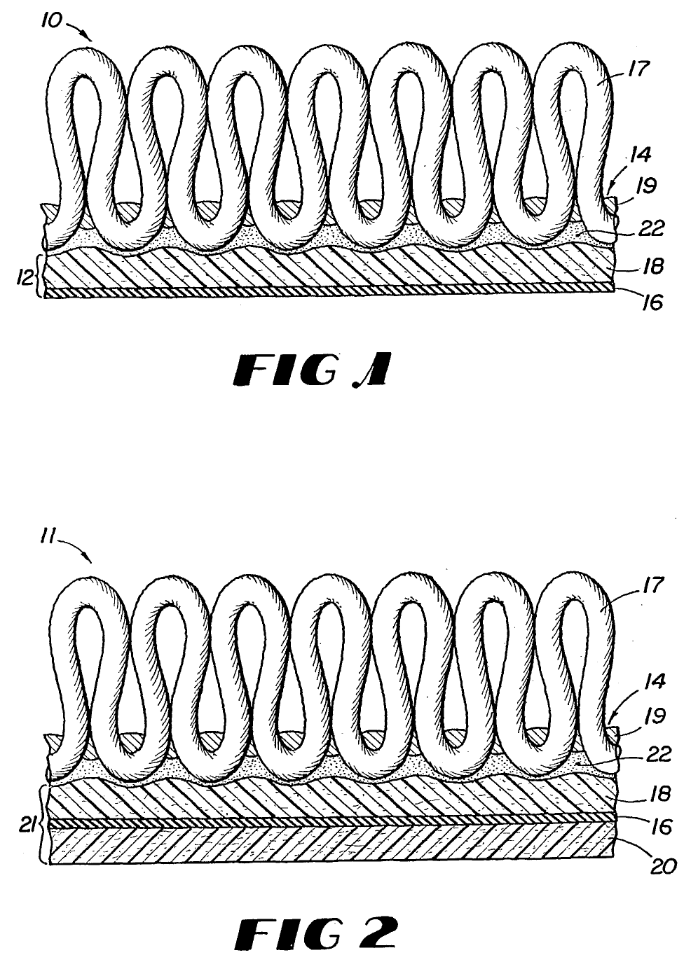

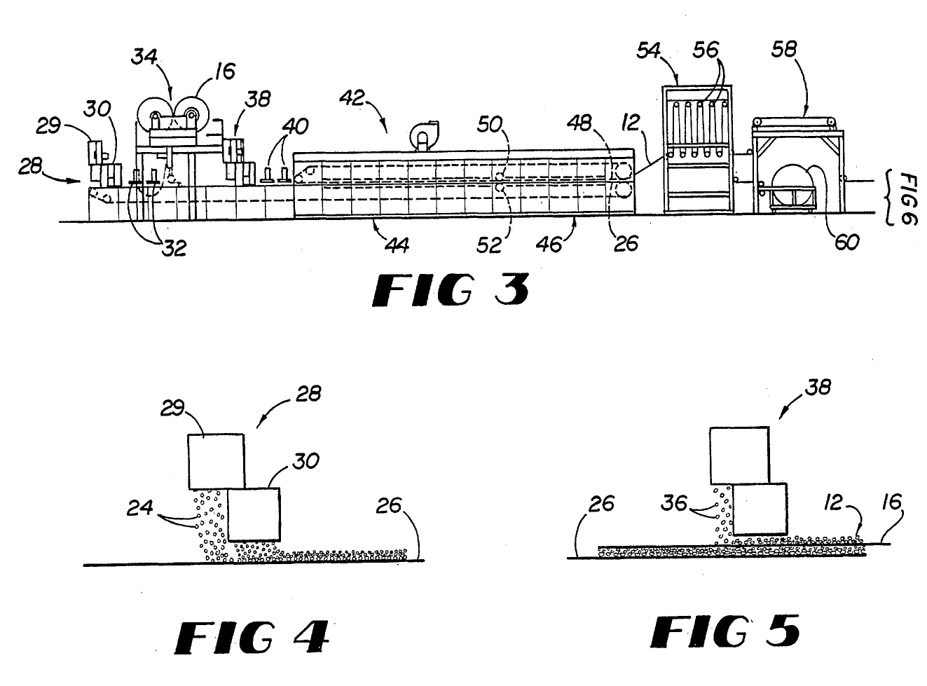

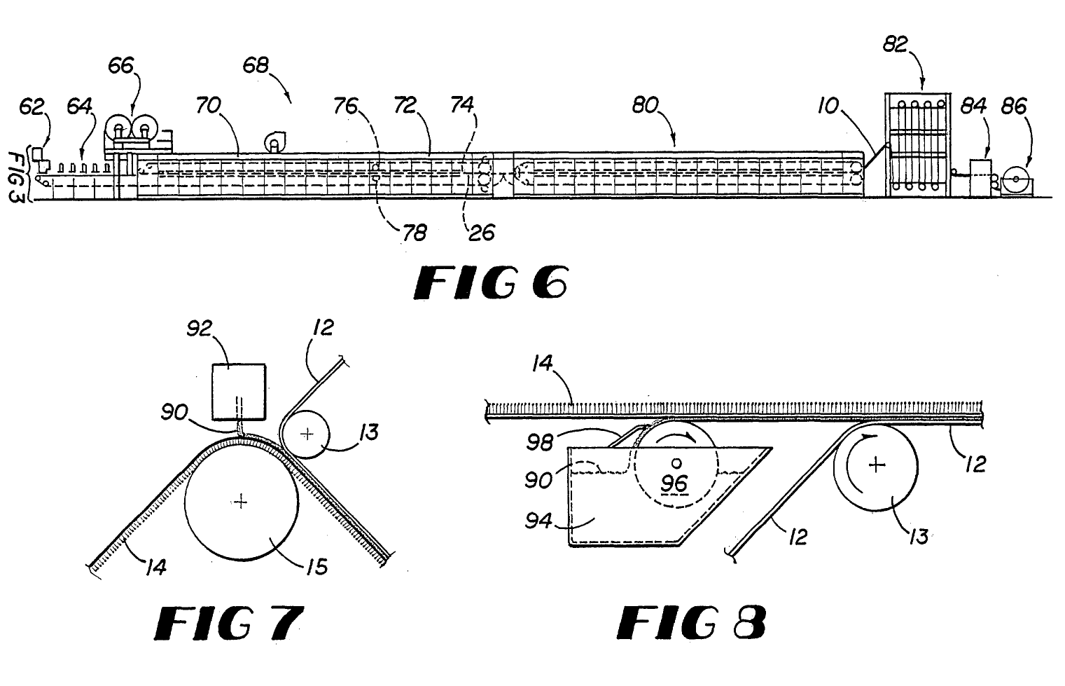

This invention involves an improved process for manufacturing carpet and other flooring. The flooring composite formed by the process, one embodiment 10 of which is shown in FIG. 1, comprises a backing 12 bonded to a face cloth 14. In composite 10, face cloth 14 includes yarn 17 tufted into tuffing primary 19. The backing 12 is formed of an underlying mat 16 and a thermoplastic layer 15 bonded to the mat 16. In but one of numerous alternative embodiments, the composite 11 shown in FIG. 2 includes a second thermoplastic layer 20 positioned under the underlying mat 16.

While the underlying mat 16 is preferably a fiberglass mat, it may be made from any material that imparts dimensional stability to the resulting flooring composites 10 or 11, including resistance to upcurl, sirinkage, and expansion, and physical integrity to facilitate the installation, use, and reclamation of the flooring. Layers 18 and 20 are typically PVC or include PVC.

The layer 18 is preferably a vinyl sheet, but may be formed from any material that softens under heat and pressure to bond to the underlying mat 16, including, but not limited to, any thermoset or thermoplastic polymeric material, including, urethane, bitumen, modified bitumen, polyvinylchloride, polypropylene, olefin, polyester, polyurethane, nylon fiber and natural fiber, or combinations thereof. Foams and other soft or resilient materials may be used in layers 18 and 20 to provide a cushioning effect. While virgin materials may be used to form layers 18 and 20, they are preferably made from recycled materials, especially used carpet and carpet manufacturing byproducts such as carpet backing, ground carpet face yarn, edge or selvage trimmings. Other usable materials include wire and cable jacket waste, yarn, fiber waste, and cellulosic and other natural fibers. Additionally, layers 18 and 20 may include fillers and other materials that do not soften under heat and pressure provided that adequate amounts of such plastic materials are included in layer 18 or 20 to achieve the desired properties in the finished flooring.

The face cloth 14 may be formed from any floor covering material, including, but not limited to, a tufted material like that depicted in FIGS. 1 and 2, fusion-bonded material, and woven, non-woven or knitted material or fabric. The fiber of the face cloth 14 may be formed from, for example, nylon, polyester, PTT (polytrimethyl terephthalate), PBT (polybutyl terephthalate), PLA (polylatic acid), polypropolyne, hemp, wool and other fibers.

Layer 18 of the backing 12 and the face cloth 14 are bonded together with an adhesive 22. It is preferable that the adhesive 22 have a low melt viscosity to facilitate penetration of the adhesive 22 into the face cloth 14 with minimal pressure. The adhesive 22 thereby encapsulates portions of yarn 17 of the face cloth 14 to ensure bundle wrap and tuft lock. Suitable adhesives include, but are not limited to, any thermoplastic polymer, including hot melt, latex, ethylene vinyl acetate, acrylic, a bitumeiious compound, or a rubber compound, or any combination of these materials. Additionally, anti-microbials, anti-dustmites, and flame retardants may be incorporated into the adhesive 22.

While the adhesive 22 may have any form at room temperature, it preferably has a form that facilitates application onto the backing 12 (or 21) or face cloth 14 of a continuous, even layer of the adhesive 22 with minimal amounts of the adhesive 22. Powder adhesive has proven particularly useful, and, for the purpose of this discussion, will be described in the embodiment detailed below to explain the process of this invention.

The continuous manufacturing process of this invention preferably involves at least two steps. The backing 12 or 21 is produced in the first step (illustrated in FIGS. 35), and the backing 12 or 21 is laminated to the face cloth 14 in the second step (illustrated in FIGS. 6-8).

Backing Formation

Granulated, preferably vinyl, pieces 24, which will form the stratum or layer 18 are first scattered onto a conveyor belt 26 using, for instance, a dual scattering unit 28. As explained above, other polymeric materials may be used to form layers 18 and 20. In contrast with existing backing layer formation processes, the materials used to form the layer 18 need not be consistent in size or shape. Moreover, a variety of materials may be mixed together to form the layer 18. Conveyor belt 26 is preferably made from a heat resistant material that prevents the resulting backing 12 from adhering to the belt 26 during the manufacturing process. PTFE (tetraflouroethylene or “teflon”) coated glass fiber belts work particularly well in this application.

The dual scattering unit 28 comprises two scattering units, one for larger granules or particles 29 and a second for smaller particles 30 (see FIG. 4). The scattered vinyl pieces 24 are then moved on belt 26 through an edge trimming device (not shown). The edge trimming device removes vinyl pieces 24 that have been scattered beyond the desired width of the backing 12. While a number of devices may be used to perform this function, a preferred edge trimming device vacuums pieces 24 that have been scattered beyond the desired width off of the conveyor belt 26. In this way, these outlying vinyl pieces 24 may be redeposited onto the conveyor belt 26 by the scattering units 29, 30.

Conveyor belt 26 then carries the vinyl pieces 24 under a bank of infrared (IR) heaters 32 that heat the vinyl pieces 24 to a temperature in a range of 100°-300° Celsius, depending on the speed of the conveyor belt 26 as it passes under the IR heaters 32. However, alternative temperatures may be necessary depending on the material used. Mat 16 is fed from an unwinding station 34 and positioned on top of the vinyl pieces 24 to form the bi-layered backing 12. The mat 16 may be heated prior to being placed on top of the vinyl pieces 24, preferably to a temperature in a range of 100°-300° Celsius. While heating of either or both of the vinyl pieces 24 and underlying mat 16 prior to their merger is not always required or necessary, such heating facilitates bonding between the two components. In an alternative embodiment, the order of formation of the bi-layered backing 12 may be reversed and mat 16 may be laid directly onto the conveyor belt 26 and the vinyl pieces 24 then scattered directly onto mat 16.

FIG. 5 illustrates the optional step of depositing a second stratum or layer of vinyl pieces 36 onto the bi-layered backing 12 to form a tri-layered backing 21. After bonding of the vinyl pieces 24 to mat 16, vinyl pieces 36 may be added by an optional dual scattering unit 38. This second layer of vinyl pieces 36 sandwiches the underlying mat 16 between the two layers 15 and 20 of vinyl pieces 24, 36. The resulting tri-layered backing 21 is then passed through a second edge trimming device (not shown). Incorporation of this optional second layer 20 of vinyl pieces 36 results in the embodiment of the flooring composite 11 illustrated in FIG. 2.

For purposes of the following discussion only, it is assumed that only a bi-layered backing 12 is formed by the process. Yet additional layers of vinyl pieces and or mat could also be incorporated in a backing in accordance with this invention.

Backing 12 is next fed under a second bank of infrared (IR) heaters 40 that preheat the vinyl layer 18 and mat 16 before the backing 12 is fed into the oven 42. Again, while such preheating is optional, it is desirable as it facilitates the heat transfer process within the oven 42.

The backing 12 is next fed through the oven 42, which has a heating section 44 and a cooling section 46. While any heat laminating process capable of thermally bonding thermoplastic materials, including textile fibers, various thermoplastic or thermoset polymers, as well as a variety of organic materials may be used to apply the requisite heat and pressure to the backing 12, a Thermofix® oven is particularly well-suited in this application.

An upper belt 48 is positioned in the oven 42 parallel to the conveyor belt 26. The backing 12 runs between the two conveyor belts 26, 48. Upper belt 48 is adjustable in height to influence the thickness of the backing 12. Heat is transmitted through heat plates (not show), through belts 26, 48, and into the backing 12 to fuse and otherwise bond the vinyl pieces 24 into layer 18 and to mat 16. While the optimal oven temperature depends upon the types of materials being heated and the speed of the conveyor belt 26, oven temperatures between 180°-250° Celsius will be suitable for most materials and belt speeds.

After heating, backing 12 is next passed through a pair of adjustable calendaring rollers 50, 52, which are separated approximately the desired thickness of the backing 12. When the backing 12 enters the rollers 50, 52, the rollers 50, 52 exert contact pressure on the backing 12 to ensure that the backing 12 exiting the rollers 50, 52 has a uniform desired thickness. The thickness of the backing 12 obviously depends upon the application in which it will be used, but the backing 12 may have any desired thickness. A backing thickness (and therefore the separation gap between the rollers 50, 52) between 0.5-2 millimeters is suitable for many applications. The backing 12 then passes through the cooling section 46, where cooling of the backing 12 is accomplished with cooling plates (not shown).

After passing through the cooling section 46, the now-cooled backing 12 exits oven 42 and is received by a web accumulator 54, which stores the backing 12 prior to being wound. The web accumulator 54 operates by carrying the backing 12 around a series of rollers 56 that move up and down to increase the storage capacity of accumulator 54. At this stage of manufacture, the backing 12 can either be fed into a wind-up station 58 with roll exchange 60 for storage or use in other applications or, preferably, can be laminated immediately to the face cloth 14, thereby avoiding costly interruptions in the manufacturing process.

Lamination

FIGS. 6-8 illustrate alternative lamination processes. In FIG. 6, a dual scattering unit 62 first scatters powder adhesive (not shown) onto backing 12. In an alternative embodiment, the powder adhesive is scattered onto the face cloth 14. The powder adhesive and backing 12 are then exposed to a bank of IR heaters 64. The face cloth 14 is then fed from an unwinding machine 66 and aligned on top of the backing 12 and the powder adhesive to form a flooring composite 10. IR heaters 64 preheat the flooring composite 10 to a temperature in a range of 100°-300° Celsius prior to being fed into the oven 68.

The flooring composite 10 is then fed into oven 68, which may be identical to oven 42. Once again, a variety of heat laminating processes may be used. Oven 68 has a heating section 70 and a cooling section 72. An upper belt 74 is positioned in the oven 68 parallel to the conveyor belt 26. The flooring composite 10 runs between the two conveyor belts 26, 74. Upper belt 74 is adjustable in height to influence the thickness of the flooring composite 10 and to accommodate flooring 10 of different thicknesses. Heat is transmitted from heating plates (not shown), through belts 26, 74, and into the flooring composite 10, thereby melting the powder adhesive and thermo-bonding the backing 12 and the face cloth 14 into a single laminated flooring composite 10. The flooring composite 10 then passes through a pair of adjustable calendaring rollers 76, 78 that apply pressure to the flooring composite 10 to facilitate bonding and gauge-setting of the flooring composite 10.

Typically, less heat and pressure is necessary and desirable during the lamination process as compared to that required during the backing layer formation process. An oven 68 temperature in the range of 150°-200° Celsius is suitable for most laminating applications. Moreover, the separation gap between the rollers 76, 78 should be set so that the rollers 76, 78 lightly press on the flooring composite 10 as it passes to ensure adhesion between the backing 12 and face cloth 14 without crushing the face of the face cloth 14. A roller separation gap of between 6-12 mm is suitable for most applications.

The flooring composite 10 then enters the cooling section 72. An additional cooling unit 80 may be provided to further facilitate the cooling process.

An alternative lamination process to that depicted in FIG. 6 is the slot-die process, an example of which is shown in FIG. 7. A liquid adhesive 90 is fed through a slot-die applicator 92 and onto the face cloth 14 being transported along by the flooring roller 15. The face cloth 14 is then mated with the backing 12 being transported along by the backing roller 13. In a second alternative shown in FIG. 8, the liquefied adhesive 90 may be contained in a tub 94. A roller 96 dips into the tub 94, thereby coating the outside of the roller 96 with adhesive 90. The outside of the roller 96 then contacts the face cloth 14 traveling adjacent the roller 96, which then mates with the backing 12. A control device 98 contacts the roller 96 before it applies adhesive 90 to the face cloth 14 to regulate the amount of adhesive 90 applied and thereby reduce adhesive waste.

After the backing 12 and the face cloth 14 have been laminated together to form the flooring composite 10, composite 10 is fed into an accumulator 82. Accumulator 82 feeds the flooring composite into a selvage and web trimmer 84, which trims the edges of the flooring composite 10 and cuts the flooring composite 10 into predetermined roll lengths. The flooring composite 10 is wound on a roll exchange 86 and can then be transported to a separate cutting station for cutting into flooring tiles or other modules if desired.

Suitable conveyor belt and oven assemblies for practicing this invention can be obtained from Schott & Meissner, Postfach 1143; 74568 Blaufelden/Germany.

The foregoing is provided for the purpose of illustrating, explaining and describing embodiments of the present invention. Further modifications and adaptations to these embodiments will be apparent to those skilled in the art and may be made without departing from the spirit of the invention or the scope of the following claims.

We claim:

1. A continuous process for manufacturing flooring comprising:
a. forming a face cloth;
b. forming a backing by bonding a plastic layer comprising polymeric material to a mat, applying heat and pressure to the layer and mat so that the layer at least partially softens to bond with the mat; and
c. after forming the backing, conveying the backing to a laminating station; and laminating the backing to the face cloth to form a flooring composite.

2. The process of claim 1, further comprising positioning adhesive between the backing layer and the face cloth to adhere the backing layer to the face cloth.

3. The process of claim 2, where the laminating comprises applying heat and pressure to the flooring composite to at least partially melt and bond the adhesive to the backing and the face cloth.

4. The process of claim 3, wherein the laminating heat and pressure differ from the bonding heat and pressure.

5. The process of claim, wherein forming the backing further comprises:
a. positioning the layer on a conveyor belt; and
b. positioning the mat on top of the layer to form the backing before applying the heat and pressure.

6. The process of claim 5, wherein positioning the layer comprises depositing a first stratum of granules on the conveyor belt.

7. The process of claim 5, further comprising positioning a second layer comprising polymeric materials on top of the mat.

8. The process of claim 7, herein positioning the second layer comprises depositing a second stratum of granules on the mat.

9. The process of claim 5, wherein the applying heat and pressure comprises conveying the backing between a pair of rollers that apply first pressure.

10. The process of claim 5, further comprising cooling the backing.

11. The process of claim 1, wherein forming the backing further comprises:
a. positioning the mat on a conveyor belt; and
b. positioning the plastic layer on the mat to form the backing; and
exposing the backing to the first heat.

12. The process of claim 11, wherein positioning the layer comprises depositing a stratum of granules on top of the mat.

13. The process of claim 11, further comprising conveying the backing between a pair of rollers that apply a first amount of pressure.

14. The process of claim 11, further comprising cooling the backing.

15. The process of claim 1, wherein laminating comprises:
a. applying an adhesive to the face cloth;
b. positioning the backing on the face cloth and in contact with the adhesive to form a flooring composite; and
c. exposing the flooring composite to second heat.

16. The process of claim 15, wherein the applying an adhesive comprises scattering a powder adhesive onto the face cloth.

17. The process of claim 15, wherein the applying an adhesive comprises using a slot-die applicator to apply a liquid adhesive to the face cloth.

18. The process of claim 1, wherein the laminating the backing layer and the face cloth comprises:
a. applying an adhesive to the backing;
b. positioning the face cloth on the backing and in contact with the adhesive to form a flooring composite; and
c. exposing the flooring composite to second heat.

19. The process of claim 18, wherein the applying an adhesive comprises scattering a powder adhesive onto the backing layer.

20. The process of claim 18, wherein the applying an adhesive comprises using a slotdie applicator to apply a liquid adhesive to the backing.

21. The process of claim 1, further comprising cutting the flooring composite into modules.

22. The process of claim 1, wherein the plastic layer comprises recycled PVC materials.

23. The process of claim 20, wherein the recycled PVC materials comprise carpet byproducts.

24. The process of claim 1, wherein the mat comprises fiberglass.

25. The process of claim 1, wherein the face cloth comprises tufted material.

26. Tile process of claim 1, wherein the face cloth comprises woven material.

27. The process of claim 1, wherein the adhesive comprises a thermoplastic polymer.

28. The process of claim 1, wherein the adhesive comprises an anti-microbial.

29. The process of claim 1, wherein the adhesive comprises an anti-dustmite.

30. The process of claim 1, wherein the adhesive comprises a flame retardant.

31. The process of claim 1, wherein the polymeric material comprises a thermoset polymer.

32. The process of claim 1, wherein the polymeric material comprises a thermoplastic polymer.

33. A continuous process for manufacturing flooring comprising:
a. depositing granules on a conveyor belt, wherein the granules comprise recycled polymeric materials;
b. positioning a fiberglass mat on top of the granules;
c. applying a first amount of heat and a first amount of pressure to the backing layer so that the granules at least partially soften to bond with the fiberglass mat to form a backing;
d. applying an adhesive to the backing;
e. positioning a face cloth on the backing layer and in contact with the adhesive to form a flooring composite; and
f. applying a second amount of heat and a second amount of pressure to the flooring composite to at least partially melt the adhesive to the backing layer and the face cloth, wherein the second amount of heat and the second amount of pressure can be adjusted to differ from the first amount of heat and the first amount of pressure.

34. A system for manufacturing flooring, comprising:
a. a backing forming station wherein a plastic layer is bonded to a mat to form the backing, by applying a first amount of heat and a first amount of pressure to the layer and mat so that the layer at least partially softens to bond with the mat; and
b. a laminating station for laminating the backing layer to a face cloth to form a flooring composite, by positioning an adhesive between the backing and the face cloth to adhere the backing to the face cloth and by applying a second amount of heat and a second amount of pressure to the flooring composite to at least partially melt the adhesive.

35. A process for manufacturing flooring backing comprising:
a. depositing granules on a substrate, wherein the granules comprise at least one polymeric material;
b. positioning a mat in contact with the granules; and
c. applying heat and pressure to the granules and the mat so that the granules at least partially soften to bond with the mat.

36. The process of claim 35, wherein the granules comprise a mixture of polymeric materials.

37. The process of claim 36, wherein the mixture comprises recycled polymeric materials.

38. The process of claim 36, wherein the granules are of different sizes and shapes.
